(19) United States
(12) Patent Application Publication
(10) Pub. No.: US 2025/0048958 A1
(43) Pub. Date: Feb. 13, 2025

(54) A MULTI-FUNCTIONAL ROBOT WITH INTEGRATED CONTAINER AND EXTENDABLE TOOL SYSTEM

(71) Applicant: EEVE BV, Waregem (BE)

(72) Inventor: Wesley LORREZ, Waregem (BE)

(21) Appl. No.: 18/718,695

(22) PCT Filed: Dec. 13, 2022
(86) PCT No.: PCT/EP2022/085523

§ 371 Date: Jun. 11, 2024

(30) Foreign Application Priority Data
Dec. 14, 2021 (BE) 2021/5981

(51) Int. Cl. A01D 34/00; B25J 9/00; B25J 9/16; B25J 11/00

(52) U.S. Cl. CPC A01D 34/008; B25J 9/0087; B25J 9/1661; B25J 9/1676; B25J 11/008

(57) ABSTRACT

The current invention relates to a multi-functional robot (100) that includes one or more extendable robotic arms (102a, 102b). Each robotic arm (102a, 102b) is attached to body of the robot at proximal end of an extendable robotic arm (102a, 102b). Each extendable robotic arm (102a, 102b) includes a tool system (104) at the distal end of the extendable robotic arm and an internal cavity (106), accessible by one or more openings (106a, 106b) on the body of the robot (100). The openings (106a, 106b) are preferably covered by respective lids (108a, 108b). The multi-functional robot (100) further includes a processor and a memory communicatively coupled to the processor. The memory stores processor instructions, which, on execution, causes said processor to control operations of the one or more extendable robotic arms (102a, 102b) and the plurality of lids (108a, 108b) for performing one or more pre-defined functions.

### FIELD OF THE INVENTION

The present invention relates to a robotic device such as an autonomous lawn mower or cleaning robot that is provided with a tool system to extend the working range of said device.

### BACKGROUND

Recent advancement in the field of robotic and automation have led to development of plethora of autonomous and/or semi-autonomous robots that can assist in performing chores that can be automated. The market today is replete with robots that can perform operations that include cleaning of a pre-defined region, lawn mowing, transporting, and the like.

However, when it comes to human interference required for effective functioning of such robots, the technology today is lagging behind. For example, while a robot may be configured to clean a surface, however, when an unknown object is encountered in the path of the robot, that which cannot be sucked in by vacuuming, human intervention may be required.

Similarly, the existing robots have limited set of capabilities and are mostly designed for performing one specific activity. This is because the robots may not be equipped with the necessary tool set for that enables them to perform more than one kind of activity.

Further, the existing robots are not adept at adjusting to the environmental requirements. For example, when faced with difficulties in performing a task because of the physical attributes of the objects (such as weight, shape, size, etc.) and/or the external environment (such as marshy surface, steep incline or decline, inclement weather, etc.), the physical structure of the robots may not be best suited for performing the activity efficiently.

The present invention aims to resolve at least some of the problems and disadvantages mentioned above. The aim of the invention is to provide a method which eliminates those disadvantages. The present invention targets at solving at least one of the aforementioned disadvantages.

Accordingly, a need arises to provide a multi-functional robot having capabilities for performing wide range of task. The robot also needs to be adaptable to the externalities of the environment, while also ensuring minimal human intervention.

### SUMMARY OF THE INVENTION

The present invention and embodiments thereof serve to provide a solution to one or more of above-mentioned disadvantages. To this end, the present invention relates to multi-functional robotic device according to claim 1.

Preferred embodiments of the device are shown in any of the claims 2 to 23.

In a second aspect, the present invention relates to a method/use according to claim 21.

In a third aspect, the present invention relates to a computer-readable medium for controlling operations of a multi-functional robot, according to claim 21.

In a fourth aspect, the present invention relates to a method for mowing lawn using a multi-functional robot, according to claim 23.

The robot/methods as described herein provide advantageous effects of performing wide range of task. The robot also needs to be adaptable to peculiarities of the environment, while also ensuring minimal human intervention.

### DESCRIPTION OF FIGURES

The following description of the figures of specific embodiments of the invention is merely exemplary in nature and is not intended to limit the present teachings, their application or uses. Throughout the drawings, corresponding reference numerals indicate like or corresponding parts and features.

FIG. 1 shows a right-side perspective view of a multi-functional robot integrated container and extendable tool system according to an embodiment of the present invention.

FIG. 2 shows a left-side split perspective view of an internal portion of the multi-functional robot integrated container and tool system in extended state, according to an embodiment of the present invention.

FIG. 3 shows a left-side split perspective view of an internal portion of the multi-functional robot integrated container and tool system in retracted state, according to an embodiment of the present invention.

FIG. 4A shows a top view of a multi-functional robot integrated container and tool system, according to an embodiment of the present invention.

FIG. 4B shows a bottom view of a multi-functional robot integrated container and tool system, according to an embodiment of the present invention.

FIG. 5A shows a front view of a multi-functional robot having an integrated container and tool system, according to an embodiment of the present invention.

FIG. 5B shows a rear view of a multi-functional robot having an integrated container and tool system, according to an embodiment of the present invention.

FIG. 5C shows a left-side view of a multi-functional robot having an integrated container and tool system, according to an embodiment of the present invention.

FIG. 6 shows a flowchart of a method for controlling operations of a multi-functional robot according to an embodiment of the present invention.

FIG. 7 shows a flowchart of a method mowing lawn using a multi-functional robot according to an embodiment of the present invention.

### DETAILED DESCRIPTION OF THE INVENTION

The present invention concerns a multi-functional robotic device (such as an autonomous lawn mower or cleaning robot) that is provided with a tool system to extend the working range of the device, a method for using such a device, a computer readable medium for controlling operations of such a device, and a method for mowing lawn using such a device.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the present invention.

As used herein, the following terms have the following meanings:

“A”, “an”, and “the” as used herein refers to both singular and plural referents unless the context clearly dictates otherwise. By way of example, “a compartment” refers to one or more than one compartment.

“About” as used herein referring to a measurable value such as a parameter, an amount, a temporal duration, and the like, is meant to encompass variations of +/−20% or less, preferably +/−10% or less, more preferably +/−5% or less, even more preferably +/−1% or less, and still more preferably +/−0.1% or less of and from the specified value, in so far such variations are appropriate to perform in the disclosed invention. However, it is to be understood that the value to which the modifier “about” refers is itself also specifically disclosed.

“Comprise”, “comprising”, and “comprises” and “comprised of” as used herein are synonymous with “include”, “including”, “includes” or “contain”, “containing”, “contains” and are inclusive or open-ended terms that specifies the presence of what follows e.g. component and do not exclude or preclude the presence of additional, non-recited components, features, element, members, steps, known in the art or disclosed therein.

Furthermore, the terms first, second, third and the like in the description and in the claims, are used for distinguishing between similar elements and not necessarily for describing a sequential or chronological order, unless specified. It is to be understood that the terms so used are interchangeable under appropriate circumstances and that the embodiments of the invention described herein are capable of operation in other sequences than described or illustrated herein.

The recitation of numerical ranges by endpoints includes all numbers and fractions subsumed within that range, as well as the recited endpoints.

The expression “% by weight”, “weight percent”, “% wt” or “wt %”, here and throughout the description unless otherwise defined, refers to the relative weight of the respective component based on the overall weight of the formulation.

Whereas the terms “one or more” or “at least one”, such as one or more or at least one member(s) of a group of members, is clear per se, by means of further exemplification, the term encompasses inter alia a reference to any one of said members, or to any two or more of said members, such as, e.g., any ≥3, ≥4, ≥5, ≥6 or ≥7 etc. of said members, and up to all said members.

Unless otherwise defined, all terms used in disclosing the invention, including technical and scientific terms, have the meaning as commonly understood by one of ordinary skill in the art to which this invention belongs. By means of further guidance, definitions for the terms used in the description are included to better appreciate the teaching of the present invention. The terms or definitions used herein are provided solely to aid in the understanding of the invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In a first aspect, the invention relates to a multi-functional robot or autonomous vehicle. The multi-functional robot comprises one or more robotic arms that are preferably extendable. Each robotic arm may be attached to body of the robot at proximal end of a robotic arm. Each robotic arm comprises a tool system at the distal end of the robotic arm and an internal cavity, accessible by one or more openings on the body of the robot. The openings are preferably covered by a lid. The multi-functional robot further comprises a processor and a memory communicatively coupled to the processor. The memory stores processor instructions, which, on execution, causes said processor to control operations of the one or more extendable robotic arms and the plurality of lids for performing one or more pre-defined functions.

The inventors have unexpectedly observed that the use of the multi-functional robot described herein provides a novel mechanism for leveraging the capabilities of robots that entails ability of performing wide range of task by virtue of the toolset and the container integrated with the robot. Also, the internal structure of the container of the multi-functional robot facilitates handling and transport of objects that are either difficult to handle due to their weight, shape, and/or sized. Further, the proposed multi-functional robot may be suited to all terrains and may be adaptable to the peculiarities of the environment, in which it operates, by being able to adjust the orientation of the container according to the terrain and purpose. The proposed multi-functional robot thus additionally ensures minimal human intervention.

In a preferred embodiment, the tool system comprises a plurality of prongs for gripping an object. The plurality of prongs comprise mechanical grippers, vacuum grippers, magnetic grippers, adhesive grippers, hydraulic gripper, servo-electric grippers, pneumatic grippers. The tool system comprises a universal tool kit.

In a preferred embodiment, the one or more extendable robotic arms may be configured to have 6-degrees of freedom (6DOF) of motion. The processor may be configured to control yaw, pitch, and roll of said one or more extendable robotic arms for performing said one or more pre-defined functions.

In a preferred embodiment of the invention, the surface of the internal cavity may be at a downward incline, preferably towards an opening. Further, the opening towards the downward incline comprises a lid. The lid, when opened, may be configured to create a downward incline between the opening and the surface of operation of the multi-functional robot.

In an embodiment, the body of the container may be provided with two openings. The openings are connected to each other by a gliding mechanism created by the inclined surface of the internal cavity.

In an embodiment, the downward incline towards one of the openings may be created by elevating a portion of said multi-functional robot using said one or more robotic arms.

In an embodiment, the processor may be communicatively connected to a remote device and/or a server for receiving one or more instructions for performing the pre-defined functions. The processor may be further configured to receive instructions for performing the one or more pre-defined functions based on voice commands and/or gestures.

In an embodiment, the multi-functional robot comprises one or more navigation sensors and one or more image sensors. The sensors enable configuring the multi-functional robot to determine path of operation and one or more obstacles present in the determined path of operation.

In an embodiment, the multi-functional robot may be configured to autonomously perform the one or more pre-defined functions based on the determined path of operation. The determined path of operation includes, but is not limited to, a terrestrial path, an aerial path, a marine path.

In an embodiment, the robot may be configured to traverse said determined path of operation by means of wheels.

In an embodiment, the one or more pre-defined functions include, but are not limited to, weeding, cleaning, repairing, and transporting. In an embodiment, the multi-functional robot may be powered by a rechargeable battery.

In another preferred embodiment, the multi-functional robot may be a lawn mower. The mowing operation may be performed by one or more mulching blades integrated with the bottom portion of the body of the multi-functional robot.

In a second aspect, the invention provides a method for controlling operations of the multi-functional robot by determining, by a robotic controller, one or more pre-defined operations to be performed by the multi-functional robot. The method further comprises controlling operations of one or more extendable robotic arms and a plurality of lids for performing one or more pre-defined functions. The body of the multi-functional robot comprises an internal cavity, accessible by an inter one or more openings on the body of the multi-functional robot. The openings are preferably covered by a lid and each of the one or more extendable robotic arms may be attached to the body of the robot at proximal end of a robotic arm. Further, each robotic arm comprises a tool system at the distal end of the robotic arm configured for performing the one or more pre-defined functions.

In a third aspect, the invention provides relates to a computer-readable medium for controlling operations of a multi-functional robot.

In a fourth aspect, the invention provides a method for mowing lawn using a multi-functional robot. The method comprises determining, by a robotic controller, one or more pre-defined paths on which lawn mowing may be performed. The method further comprises controlling, by the robotic controller, operations of one or more mulching blades integrated with the bottom portion of the body of the multi-functional robot. The body of the multi-functional robot comprises an internal cavity, accessible by one or more openings on the body of the multi-functional robot. Further, the openings are preferably covered by a lid and each of the one or more extendable robotic arms may be attached to the body of the robot at proximal end of a robotic arm. Furthermore, each robotic arm comprises a tool system at the distal end of the robotic arm configured for performing the one or more pre-defined functions.

However, it is obvious that the invention is not limited to this application. The method according to the invention can be applied in all sorts of operations that include, but are not limited to, mowing, cleaning, repairing, and transporting.

The invention is further described by the following non-limiting examples which further illustrate the invention, and are not intended to, nor should they be interpreted to, limit the scope of the invention.

The present invention will be now described in more details, referring to examples that are not limitative.

### DESCRIPTION OF FIGURES

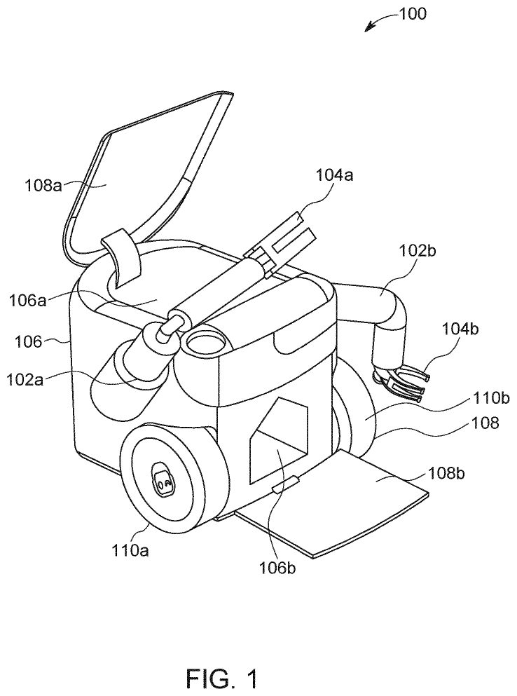

With as a goal illustrating better the properties of the invention the following presents, as an example and limiting in no way other potential applications, a description of a number of preferred applications of the method for examining the state of the grout used in a mechanical connection based on the invention, wherein: FIG. 1 shows a right-side perspective view of a multi-functional robot integrated container and extendable tool system according to an embodiment of the present invention.

With reference to the FIG. 1, there is shown a multi-functional robot 100 comprising a one or more extendable robotic arms 102a and 102b (also referred as one or more extendable robotic arms 102). Each of the one or more robotic arms 102 may be attached to body of the robot 100 at proximal end of a robotic arm. Each of the one or more robotic arms 102 comprises a tool system 104 (also referred as tool system 104a and 104b) the distal end of the robotic arm. The tool system 104a corresponds to the robotic arm 102a and the tool system 104b corresponds to the robotic arm 102b.

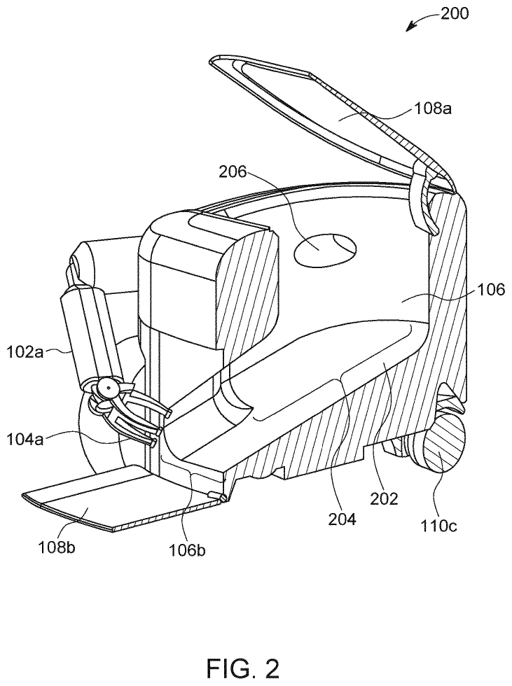

The multi-functional robot 100 further comprises an internal cavity 106, accessible by one or more openings 106a and 106b on the body of the multi-functional robot 100. Each of the openings 106a and 106b are preferably covered by a lid 108a and 108b, respectively. In an embodiment, the internal cavity 106 of the multi-functional robot 100 may be provided with a plurality of openings, such the openings 106a and 106b. The openings may be connected to each other by a gliding mechanism (explained in detail in FIG. 2).

In a preferred embodiment, the tool system 104a and 104b comprises a plurality of prongs for gripping an object. The plurality of prongs comprise mechanical grippers, vacuum grippers, magnetic grippers, adhesive grippers, hydraulic gripper, servo-electric grippers, pneumatic grippers. In another embodiment, the tool system 104a and 104b may include a universal tool kit to which one or more toolsets known in the art may be connected.

The multi-functional robot further comprises a processor and a memory communicatively coupled to the processor. The memory stores processor instructions, which, on execution, causes said processor to control operations of the one or more extendable robotic arms 102 and the lids 108a and 108b for performing one or more pre-defined functions of the multi-functional robot 100.

In a preferred embodiment, the one or more extendable robotic arms may be configured to have 6-degrees of freedom (6DOF) of motion. The processor integrated with the multi-functional robot 100 may be configured to control yaw, pitch, and roll of the one or more robotic arms 102 for performing the one or more pre-defined functions. In an embodiment, the one or more pre-defined functions include, but are not limited to, cleaning, repairing, and transporting.

In an embodiment, the multi-functional robot may be powered by a rechargeable battery. The re-chargeable battery may include, but is not limited to, lead-acid, nickel-cadmium (NiCd), nickel-metal hydride (NiMH), lithium-ion (Li-ion), lithium-ion polymer (LiPo), and rechargeable alkaline batteries. In an embodiment, the multi-functional robot may be powered by a rechargeable battery. The multi-functional robot 100 may include one or more ports, such as Universal Serial Bus (USB) belonging to types that include, but are not limited to, type-A, type-B, type-C, USB 3.0, and/or USB mini. In another embodiment, the multi-functional robot 100 may further support wireless charging based on Qi-standard.

In an embodiment, the processor of the multi-functional robot 100 may be communicatively connected to a remote device and/or a server (not shown) for receiving one or more instructions for performing the pre-defined functions. The processor may be further configured to receive instructions for performing the one or more pre-defined functions based on voice commands and/or gestures.

In an embodiment, the multi-functional robot 100 comprises one or more navigation sensors and one or more image sensors or camera systems. The sensors enable configuring the multi-functional robot to determine path of operation and one or more obstacles present in the determined path of operation. The image sensors or cameras may assist in identification, categorization, and accordingly responding to externalities encountered by the multi-functional robot 100. The one or more navigation sensors may enable the multi-functional robot 100 in charting its trajectory before commencing the operations relating to the pre-defined activity to be undertaken.

In an embodiment, the multi-functional robot 100 may be configured to autonomously perform the one or more pre-defined functions based on the determined path of operation. The determined path of operation includes, but is not limited to, a terrestrial path, an aerial path, a marine path. The autonomous operation of the multi-functional robot 100 may be based on one or more Artificial Intelligence enabled technologies for autonomous vehicles.

In an embodiment, the robot may be configured to traverse said determined path of operation by means of wheels 110a, 110b, and 110c (shown in FIG. 2). The wheels are collectively referred to as wheels 110, hereinafter.

FIG. 2 shows a left-side split perspective view of an internal portion of the multi-functional robot integrated container and tool system in extended state, according to an embodiment of the present invention.

With reference to FIG. 2, there is shown a left-side split perspective view 200 of the multi-functional robot 100. As is depicted in the figure, the multi-functional robot 100 comprises the internal cavity 106. The surface of the internal cavity 106 may be at a downward incline 202, preferably towards an opening, such as the opening 106b. Further, the opening towards the downward incline comprises the lid 108b, depicted to be in an open state in the drawing. In an embodiment, the lid 108b, when opened, may be configured to create an additional downward incline between the opening 106b and the surface of operation of the multi-functional robot 100.

In another embodiment, the internal cavity 106 of the multi-functional robot 100 may be provided with two openings 106a and 106b. The openings may be connected to each other by a gliding mechanism 204 created by the downward incline surface 202 of the internal cavity 106.

In yet another embodiment, the downward incline 202 and the gliding mechanism 204 towards one of the openings 106b may be created by the processor by commanding the extendable robotic arms 102a and/or 102b to elevate a portion of the multi-functional robot 100. The elevation may be created by a push force applied by the extendable robotic arms against a surface. For example, the extendable robotic arms may push against the surface to elevate a portion of the multi-functional robot 100, thereby creating an artificial slope within the internal cavity 106. This may facilitate sliding of one or more objects stored in the internal cavity 106, through an opening, such as the opening 106.

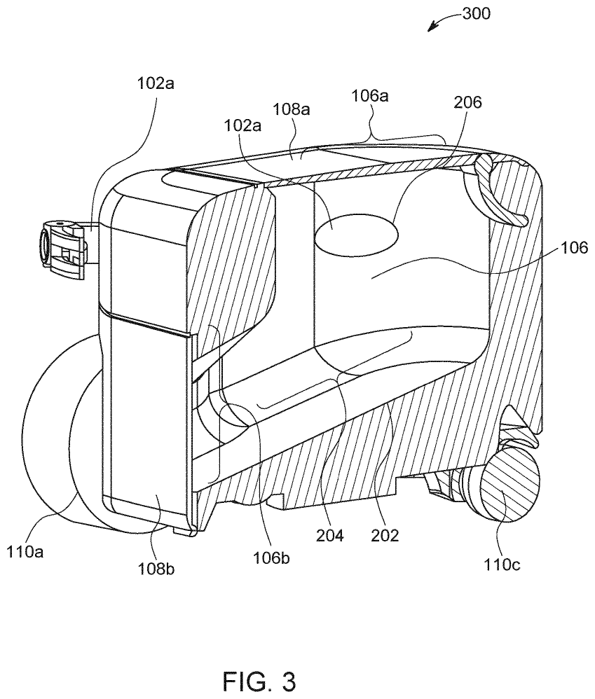

Additionally, the multi-functional robot 100 comprises a plurality of slots from which the one or more extendable robotic arms 102 may slide IN and OUT when extended and retracted, respectively. Since, the extendable robotic arm 102a is in an extended state in FIG. 2, the slot 206 is vacant. In retracted state, the extendable robotic arm 102a is configured to slide into the slot 206, as depicted in FIG. 3.

FIG. 3 shows a left-side split perspective view of a multi-functional robot integrated container and tool system in retracted state, according to an embodiment of the present invention.

With reference to FIG. 3, there is shown a left-side perspective view 300 of splitted internal cavity 106 of the multi-functional robot 100. As is depicted in the figure, the multi-functional robot 100 comprises the internal cavity 106 the openings 106a and 106b of which have been depicted in a closed state. In the closed state, the opening 106a may be covered by the lid 108a, and the opening 106b may be covered by the lid 108b.

Further, the multi-functional robot 100 comprises a plurality of slots (such as the slot 206) from which the one or more extendable robotic arms 102 may slide IN and OUT when extended and retracted, respectively. Since, the extendable robotic arm 102a is in a retracted state in FIG. 3, the slot 206 is occupied because in retracted state, the extendable robotic arm 102a is configured to slide into the slot 206.

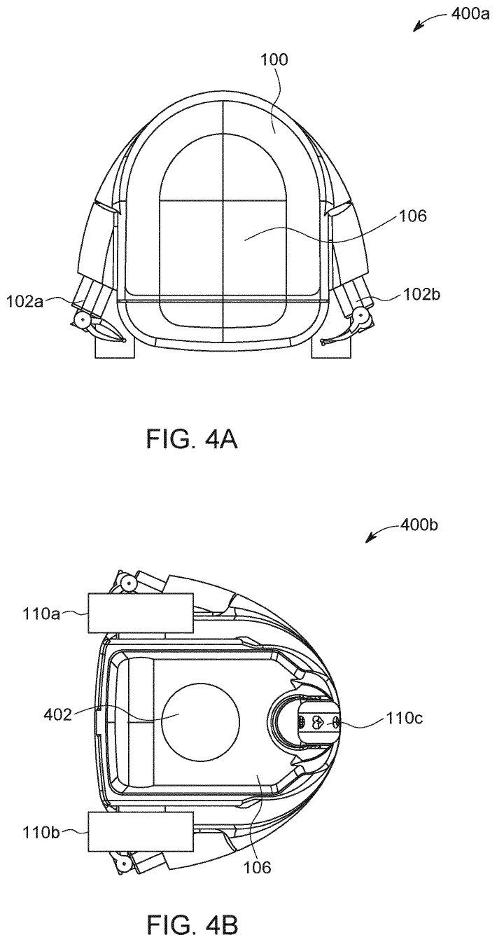

FIG. 4A shows a top view of a multi-functional robot integrated container and tool system, according to an embodiment of the present invention.

Elements of FIG. 4A have been described in conjunction with the elements depicted in FIGS. 1 to 3. With reference to FIG. 4A, the top view 400a depicts the multi-functional robot 100 having the internal cavity 106 and the one or more extendable robotic arms 102a and 102b.

FIG. 4B shows a bottom view of a multi-functional robot integrated container and tool system, according to an embodiment of the present invention.

Elements of FIG. 4B have been described in conjunction with the elements depicted in FIGS. 1 to 3. With reference to FIG. 4B, the bottom view 400b depicts the multi-functional robot 100 having a housing 402 for mulching blades.

In a preferred embodiment, when the multi-functional robot may function as a lawn mower, the mowing operation may be performed by one or more mulching blades housed in the housing 402. As depicted, the mulching blades may be integrated with the bottom portion of the body of the multi-functional robot. The processor may be configured to uncover the mulching blades from the housing 402 and extend the blades in a downward direction.

In order to perform the mowing operation, the processor may determine one or more pre-defined paths on which lawn mowing is to be performed. The processor may be further configured to control the operations of one or more mulching blades integrated with the bottom portion of the body of the multi-functional robot 100.

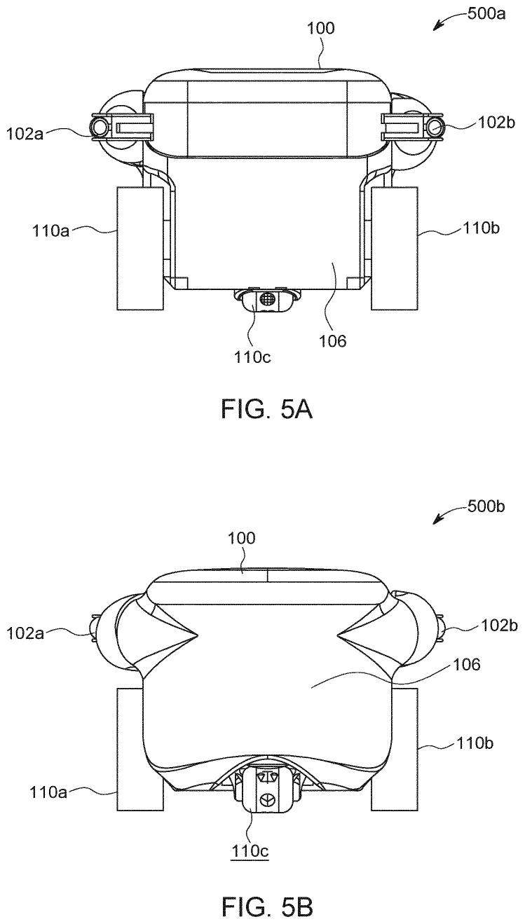

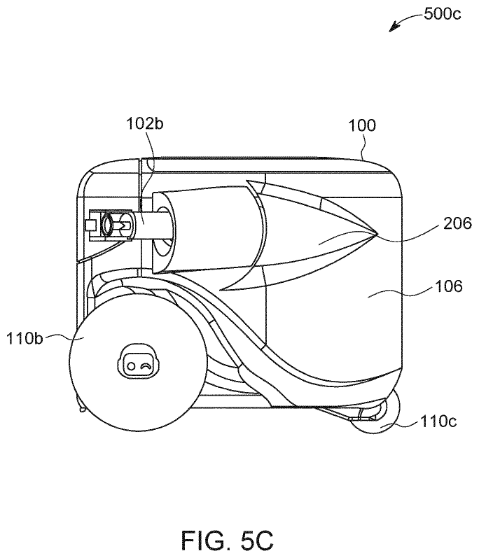

FIG. 5A shows a front view of a multi-functional robot having an integrated container and tool system, according to an embodiment of the present invention.

Elements of FIG. 5A have been described in conjunction with the elements depicted in FIGS. 1 to 3. With reference to FIG. 5A, the top view 500a depicts the multi-functional robot 100 having the internal cavity 106, wheels 110a to 110c, and the one or more extendable robotic arms 102a and 102b.

FIG. 5B shows a bottom view of a multi-functional robot having an integrated container and tool system, according to an embodiment of the present invention.

Elements of FIG. 5B have been described in conjunction with the elements depicted in FIGS. 1 to 3. With reference to FIG. 5B, the bottom view 500b depicts the multi-functional robot 100 having the internal cavity 106, wheels 110a to 110c, and the one or more extendable robotic arms 102a and 102b.

FIG. 5C shows a left-side view of a multi-functional robot having an integrated container and tool system, according to an embodiment of the present invention.

Elements of FIG. 5C have been described in conjunction with the elements depicted in FIGS. 1 to 3. With reference to FIG. 5C, the left-side view 500c depicts the multi-functional robot 100 having the internal cavity 106, wheels 110b and 100c, the extendable robotic arm 102b, and the slot 206 (explained in FIG. 2).

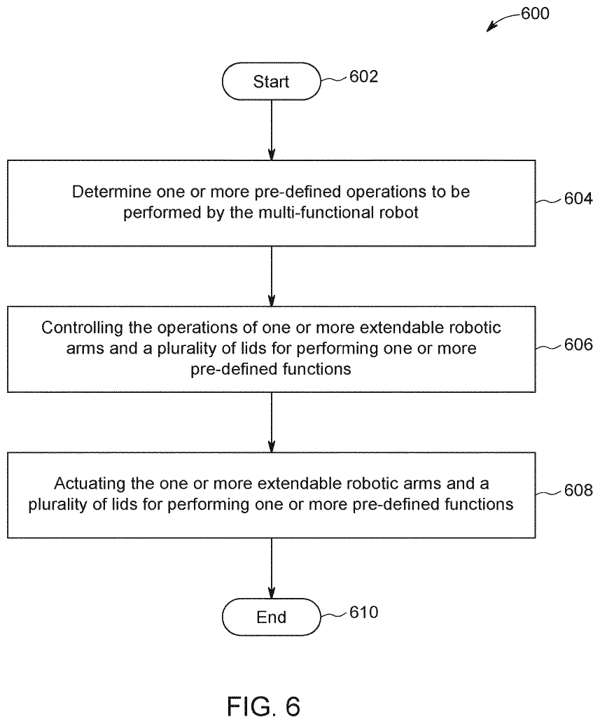

FIG. 6 shows a flowchart of a method for controlling operations of a multi-functional robot according to an embodiment of the present invention. The flowchart 600 begins at step 602 and continues to step 604.

At step 604, one or more pre-defined operations to be performed by the multi-functional robot may be determined. At step 606, the operations of one or more extendable robotic arms and a plurality of lids for performing one or more pre-defined functions may be controlled. At step 608, the one or more extendable robotic arms and a plurality of lids may be actuated for performing one or more pre-defined functions. Control passes to end step 610.

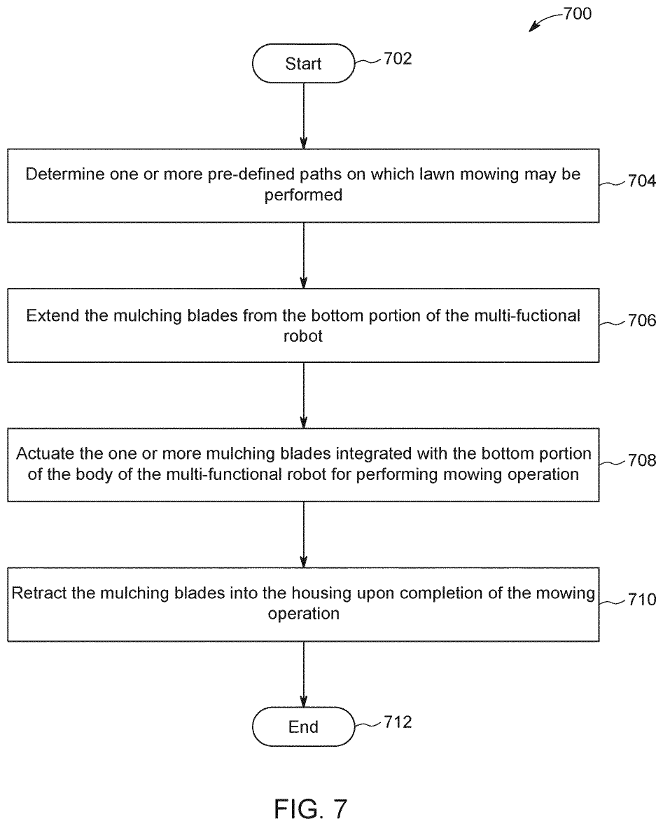

An alternative application of the invention is described in FIG. 7. Specifically, FIG. 7 shows a flowchart of a method mowing lawn using a multi-functional robot according to an embodiment of the present invention. The flowchart 700 begins at step 702 and continues to step 704.

At step 704, one or more pre-defined paths on which lawn mowing may be performed. At step 706, the mulching blades may be extended from the bottom portion of the multi-functional robot. At step 708, the one or more mulching blades integrated with the bottom portion of the body of the multi-functional robot may be actuated for performing mowing operation. At step 710, the mulching blades may be retracted into the housing upon completion of the mowing operation. The control passes to end step 712.

The present invention will now be further exemplified with reference to the following examples. The present invention is in no way limited to the given examples or to the embodiments presented in the figures.

It is clear that the method according to the invention, and its applications, are not limited to the presented examples.

The present invention is in no way limited to the embodiments described in the examples and/or shown in the figures. On the contrary, methods according to the present invention may be realized in many different ways without departing from the scope of the invention.

1. A multi-functional robot comprising:
one or more extendable robotic arms, wherein each extendable robotic arm is attached to body of said robot at proximal end of an extendable robotic arm, and wherein each extendable robotic arm comprises a tool system at said distal end of said extendable robotic arm; an internal cavity, accessible by one or more openings on said body of said robot, wherein said openings are preferably covered by respective lids;
a processor; and
a memory communicatively coupled to said processor, wherein said memory stores processor instructions, which, on execution, causes said processor to:
control operations of said one or more extendable robotic arms and said plurality of lids for performing one or more pre-defined functions.

2. The multi-functional robot according to claim 1, wherein said surface of said internal cavity is at a downward incline, preferably towards an opening.

3. The multi-functional robot according to claim 1, wherein said opening towards said downward incline comprises a lid, said lid, when opened, is configured to create a downward incline between said opening and said surface of operation of said multifunctional robot.

4. The multi-functional robot according to claim 1, wherein said body of said container is provided with two openings, said openings are connected to each other by a gliding mechanism created by said inclined surface of said internal cavity.

5. The multi-functional robot according to claim 1, wherein said downward incline towards one of said openings is created by elevating a portion of said multi-functional robot using said one or more extendable robotic arms.

6. The multi-functional robot according to claim 1, wherein said tool system comprises a plurality of prongs for gripping an object.

7. The multi-functional robot according to claim 1, wherein said plurality of prongs comprise mechanical grippers, vacuum grippers, magnetic grippers, adhesive grippers, hydraulic gripper, servo-electric grippers, or pneumatic grippers.

8. The multi-functional robot according to claim 1, wherein said tool system comprises a universal tool kit.

9. The multi-functional robot according to claim 1, wherein said each of said one or more extendable robotic arms is configured to have 6-degrees of freedom (6DOF) of motion.

10. The multi-functional robot according to claim 1, wherein said processor:
(i) is communicatively connected to a remote device and/or a server for receiving one or more instructions for performing said pre-defined functions;
(ii) is configured to receive instructions for performing said one or more pre-defined functions based on voice commands and/or gestures; or,
(iii) is configured to control yaw, pitch, and roll of said one or more extendable robotic arms for performing said one or more pre-defined functions.

11. (canceled)

12. (canceled)

13. The multi-functional robot according to claim 1, wherein the multi-functional robot comprises one or more navigation sensors and one or more image sensors, configured to determine path of operation and one or more obstacles present in said determined path of operation.

14. The multi-functional robot according to claim 1, wherein said multi-functional robot is configured to autonomously perform said one or more pre-defined functions based on said determined path of operation.

15. The multi-functional robot according to claim 1, wherein said determined path of operation is one or more of: a terrestrial path, an aerial path, a marine path.

16. The multi-functional robot according to claim 1, wherein said one or more pre-defined functions comprise weeding, cleaning, repairing, and transporting.

17. (canceled)

18. The multi-functional robot according to claim 1, wherein said robot is configured to traverse said determined path of operation by means of wheels.

19. The multi-functional robot according to claim 1, wherein said multi-functional robot is a lawn mower.

20. The multi-functional robot according to claim 19, wherein said mowing operation is performed by one or more mulching blades integrated with said bottom portion of said body of said multi-functional robot.

21. A method for controlling operations of a multi-functional robot, the method comprising:
determining, by a robotic controller, one or more pre-defined operations to be performed by said multi-functional robot;
controlling, by the robotic controller, operations of one or more extendable robotic arms and a plurality of lids for performing one or more pre-defined functions,
wherein body of said multi-functional robot comprises an internal cavity, accessible by one or more openings on said body of said multi-functional robot, and
wherein said openings are preferably covered by respective lids; and
wherein the each of the one or more extendable robotic arms is attached to the body of the robot at proximal end of a robotic arm, and wherein each extendable robotic arm comprises a tool system at the distal end of the robotic arm configured for performing the one or more pre-defined functions.

22. A computer-readable medium having stored thereon computer-executable instructions, which when executed by one or more processors, configure the one or more processors to perform the operations of claim 1.

23. A method for mowing lawn using a multi-functional robot, the method comprises:
determining, by a robotic controller, one or more pre-defined paths on which lawn mowing is to be performed;
controlling, by the robotic controller, operations of one or more mulching blades integrated with the bottom portion of the body of the multi-functional robot, wherein body of the multi-functional robot comprises an internal cavity, accessible by one or more openings on said body of the multi-functional robot, and
wherein said openings are preferably covered by respective lids; and
wherein the each of the one or more extendable robotic arms is attached to the body of the robot at proximal end of a robotic arm, and
wherein each extendable robotic arm comprises a tool system at the distal end of the extendable robotic arm configured for performing the one or more pre-defined functions.
